(19) United States
(12) Patent Application Publication
(10) Pub. No.: US 2026/0061859 A1
(43) Pub. Date: Mar. 5, 2026

(54) HIGH-VOLTAGE CIRCUITRY SYSTEM FOR VEHICLE

(71) Applicant: SUBARU CORPORATION, Tokyo (JP)

(72) Inventor: Dai OKIYAMA, Tokyo (JP)

(21) Appl. No.: 19/265,349

(22) Filed: Jul. 10, 2025

(30) Foreign Application Priority Data
Sep. 5, 2024 (JP) 2024-153057

(51) Int. Cl. B60L 50/60; B60L 1/00

(52) U.S. Cl. CPC B60L 50/60; B60L 1/00

(57) ABSTRACT

A high-voltage circuitry system for a vehicle includes a high-voltage battery unit, a traveling system, a non-traveling system, an electric power distributor, an interlock circuit, and a vehicle control processor. The high-voltage battery unit includes a high-voltage battery and a first switcher. The first switcher is configured to switch a state of supply of electric power from the high-voltage battery between an on state and an off state. The interlock circuit is configured to be brought into an open state upon occurrence of a nonnormal situation. The vehicle control processor is configured to: when the interlock circuit is brought into the open state, block the high-voltage battery by turning off the first switcher; and after blocking the high-voltage battery, confirm that the traveling system and the high-voltage battery are electrically uncoupled from each other, and turn on the first switcher.

### CROSS-REFERENCE TO RELATED APPLICATIONS

The present application claims priority from Japanese Patent Application No. 2024-153057 filed on September 5, 2024, the entire contents of which are hereby incorporated by reference.

### BACKGROUND

The disclosure relates to a high-voltage circuitry system for a vehicle.

A vehicle such as an electric vehicle or a hybrid vehicle includes a high-voltage battery with which a travel motor is driven. The vehicle further includes high-voltage circuitry configured to supply electric power from the high-voltage battery to traveling devices (i.e., a drive mechanism for travel of the vehicle) and non-traveling devices (i.e., a non-traveling mechanism).

In a nonnormal situation such as where an unexpected event including contact of the vehicle occurs or maintenance and inspection are conducted, the high-voltage circuitry is blocked to thereby stop the supply of the electric power from the high-voltage battery, to prevent an unanticipated incident including an electric shock. For example, in the situation where the unexpected event of the vehicle occurs, an interlock circuit provided in the high-voltage circuitry is brought into an open state by an impact caused by the unexpected event. Upon detecting that the interlock circuit is in the open state, control is performed to block the supply of the electric power from the high-voltage battery. In other words, the traveling devices and the non-traveling devices are not supplied with the electric power.

Such an interlock circuit finds various applications. Japanese Unexamined Patent Application Publication No. 2020-58123 discloses a control device that controls an electric compressor as a high-voltage apparatus with an interlock loop. The interlock loop is annexed to a connector that couples the electric compressor to the high-voltage battery. The control device is configured to detect whether the connector is coupled or uncoupled, based on an open state and a closed state of the interlock loop. The control device is configured to, when detecting that the connector is uncoupled, forcibly discharge residual charge of a smoothing capacitor in the electric compressor.

### SUMMARY

An aspect of the disclosure provides a high-voltage circuitry system for a vehicle. The high-voltage circuitry system includes a high-voltage battery unit, a traveling system, a non-traveling system, an electric power distributor, an interlock circuit, and a vehicle control processor. The high-voltage battery unit includes a high-voltage battery and a first switcher. The first switcher is configured to switch a state of supply of electric power from the high-voltage battery between an on state and an off state. The traveling system includes a traveling device configured to cause the vehicle to travel. The traveling system is configured to be driven by the electric power from the high-voltage battery. The non-traveling system includes an in-vehicle device indirectly involved in causing the vehicle to travel. The non-traveling system is configured to be driven by the electric power from the high-voltage battery. The electric power distributor is configured to distribute the electric power supplied from the high-voltage battery to the traveling system and the non-traveling system. The interlock circuit is provided in a route of the supply of the electric power from the high-voltage battery unit to the traveling system and the non-traveling system via the electric power distributor. The interlock circuit is configured to be brought into an open state upon occurrence of a nonnormal situation. The vehicle control processor is configured to control and monitor the high-voltage battery unit, the traveling system, the non-traveling system, the electric power distributor, and the interlock circuit. The vehicle control processor is configured to: when the interlock circuit is brought into the open state, block the high-voltage battery by turning off the first switcher; and after blocking the high-voltage battery, confirm that the traveling system and the high-voltage battery are electrically uncoupled from each other, and turn on the first switcher.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating an exemplary configuration of high-voltage circuitry of a high-voltage circuitry system for a vehicle according to one example embodiment of the disclosure.

FIG. 2 is a flowchart illustrating exemplary control to be performed by a vehicle control processor of the high-voltage circuitry system illustrated in FIG. 1.

FIG. 3 is a diagram illustrating an exemplary configuration of the high-voltage circuitry illustrated in FIG. 1, in which an interlock circuit is in an open state and a system main relay is blocked.

FIG. 4 is a diagram illustrating an exemplary configuration of the high-voltage circuitry illustrated in FIG. 1, in which the vehicle control processor transmits a control signal adapted to discharge residual charge of the vehicle to a motor control processor.

FIG. 5 is a diagram illustrating an exemplary configuration of the high-voltage circuitry illustrated in FIG. 1, in which the vehicle control processor turns on the system main relay to thereby supply a non-traveling system with electric power of a high-voltage battery.

### DETAILED DESCRIPTION

In a nonnormal situation such as where an unexpected event including contact of a vehicle occurs, control that blocks supply of electric power from a high-voltage battery to traveling devices and non-traveling devices is performed based on an open state of an interlock circuit. Thereafter, the vehicle remains in a standby state in which the supply of the electric power from the high-voltage battery is blocked, until certain processing or the next operation of bringing the vehicle into a normal state is performed. In a case of the unexpected event, the certain processing or the next operation is performed upon arrival of a rescue worker. Because the supply of the electric power not only to a drive mechanism for travel of the vehicle but also to a non-traveling mechanism (i.e., the non-traveling devices) indirectly involved in the travel of the vehicle is blocked, an air conditioner and a communication device are made unusable while the vehicle is in the standby state. This can lead to a secondary effect including sickness.

It is desirable to provide a high-voltage circuitry system for a vehicle that makes it possible to automatically resolve a state in which a non-traveling device is unusable in a standby period when supply of electric power from a high-voltage battery unit is blocked in a nonnormal situation.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

In the following, a high-voltage circuitry system for a vehicle according to an example embodiment of the disclosure will be described in detail with reference to the accompanying drawings. First, an exemplary configuration of high-voltage circuitry 10 to be applied to the high-voltage circuitry system will be described. Thereafter, various types of control to be performed by a vehicle control processor (hereinafter referred to as an "EV-ECU") 30 upon contact of the vehicle will be described.

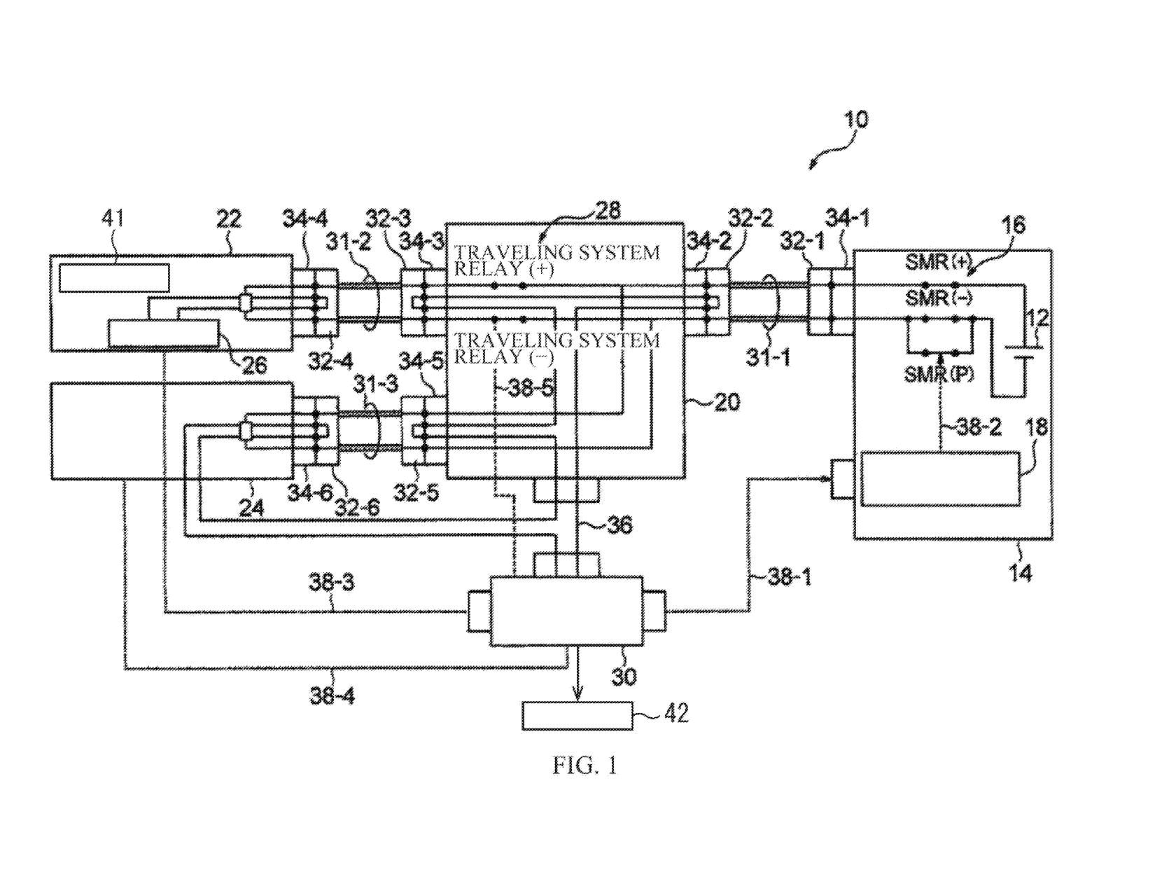

FIG. 1 is a diagram illustrating the exemplary configuration of the high-voltage circuitry 10 of the high-voltage circuitry system according to the present example embodiment. The high-voltage circuitry 10 may supply electric power of a high-voltage battery 12 to a traveling system 22 and a non-traveling system 24. The high-voltage battery 12 may be mounted in a high-voltage battery unit 14. The high-voltage battery unit 14 may include a system main relay (hereinafter referred to as an "SMR") 16 and a battery management system (hereinafter referred to as a "BMS") 18. The SMR 16 switches a state of supply of the electric power from the high-voltage battery 12 between a supply state (i.e., an on state) and a blocked state (i.e., an off state). The BMS 18 may control an operating state of the SMR 16. In one embodiment, the SMR 16 may serve as a "first switcher".

The electric power of the high-voltage battery 12 is distributed by an electric power distributor 20 to the traveling system 22 and the non-traveling system 24. The traveling system 22 may be involved in travel of the vehicle, and include traveling devices such as a motor or an inverter. The non-traveling system 24 may be indirectly involved in the travel of the vehicle, and include in-vehicle devices such as an electric compressor or a heater. The traveling system 22 may include a motor control processor (hereinafter referred to as an "MG-ECU") 26 that controls devices such as the motor.

The electric power distributor 20 may include a traveling system relay 28 that switches the state of the supply of the electric power from the high-voltage battery unit 14 to the traveling system 22 between the supply state (i.e., the on state) and the blocked state (i.e., the off state). The operation of the traveling system relay 28 may be monitored and controlled by the EV-ECU 30. In one embodiment, the traveling system relay 28 may serve as a "second switcher".

The EV-ECU 30 may monitor and control respective operations of components including the BMS 18 included in the high-voltage battery unit 14, the MG-ECU 26 included in the traveling system 22, and the non-traveling system 24, in addition to the traveling system relay 28 described above. The BMS 18 may be monitored and controlled by performing on and off control of an operation of the SMR 16.

In some embodiments, when the high-voltage circuitry 10 is blocked in a nonnormal situation such as the contact of the vehicle, the MG-ECU 26 of the EV-ECU 30 may be monitored and controlled by performing control that discharges residual charge of the vehicle including the devices such as the motor or the inverter of the traveling system 22. In some embodiments, when the control that discharges the residual charge is performed, the non-traveling system 24 may be controlled by performing an operation such as monitoring a decrease in voltage of the non-traveling system 24.

The high-voltage battery unit 14 and the electric power distributor 20 may be coupled to each other with a cable 31-1 and connectors 32-1 and 32-2. The electric power distributor 20 and the traveling system 22 may be coupled to each other with a cable 31-2 and connectors 32-3 and 32-4. The electric power distributor 20 and the non-traveling system 24 may be coupled to each other with a cable 31-3 and connectors 32-5 and 32-6. Fitting the connectors 32-1 to 32-6 respectively into receptacles 34-1 to 34-6 may form a supply route of the electric power.

The high-voltage circuitry 10 described above may be provided with an interlock circuit 36 that detects that the high-voltage circuitry 10 is blocked. A circuit configuration of the interlock circuit 36 will be described below.

In the high-voltage circuitry 10 illustrated in FIG. 1, the interlock circuit 36 may be formed when the connectors 32-2, 32-3, 32-5, and 32-6 are fitted respectively into the receptacles 34-2, 34-3, 34-5, and 34-6. The interlock circuit 36 may be one electrical closed loop serving as an interlock system. An open state and a closed state of the interlock circuit 36 may be monitored by the EV-ECU 30.

When the interlock circuit 36 is brought into the open state in the nonnormal situation such as where an unexpected event including the contact of the vehicle occurs or maintenance and inspection are conducted, the EV-ECU 30 may typically transmit a control signal adapted to block the SMR 16, to the BMS 18 included in the high-voltage battery unit 14, to thereby block the SMR 16. This prevents an unanticipated incident including an electric shock with a high voltage.

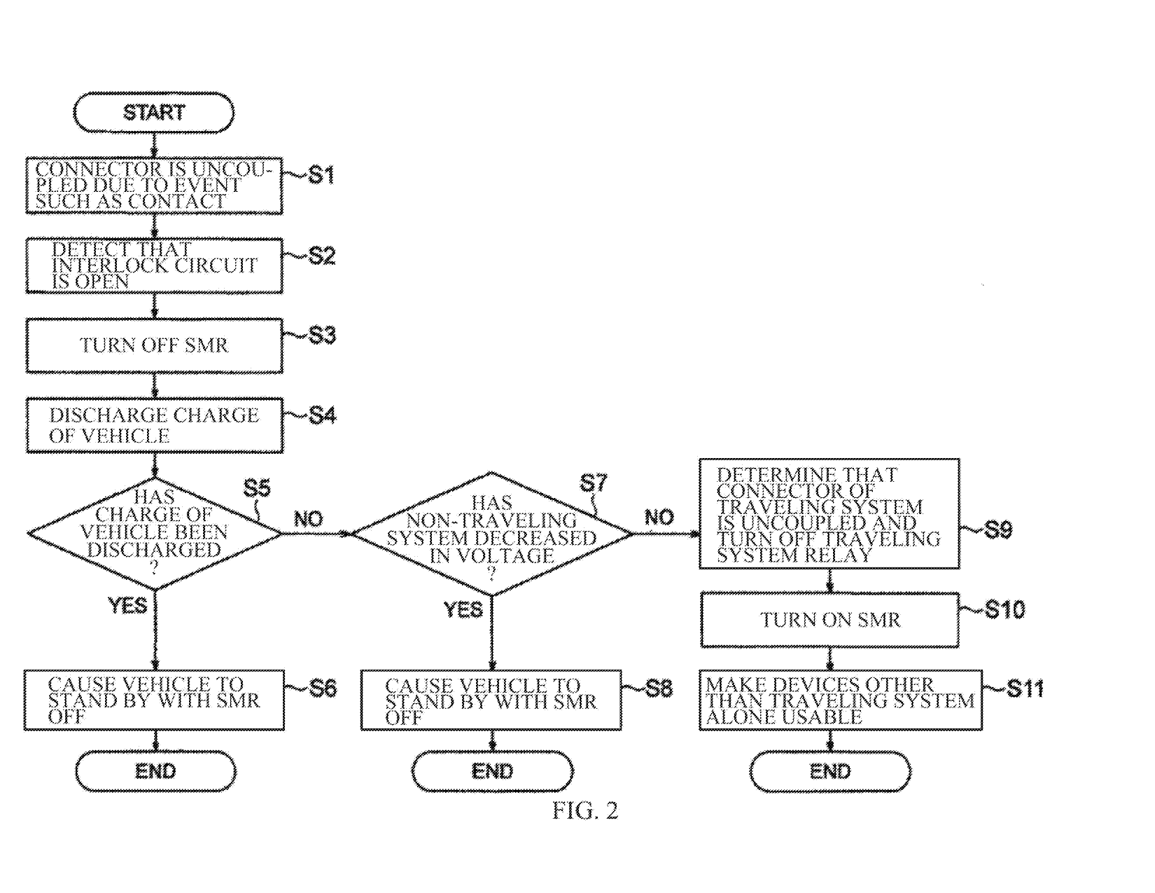

FIG. 2 is a flowchart illustrating exemplary control to be performed by the EV-ECU 30 of the high-voltage circuitry system according to the present example embodiment.

When the vehicle has gotten involved in a contact event in traveling, any of the connectors 32-2, 32-3, 32-5, and 32-6 forming the interlock circuit 36 may be uncoupled (step S1) to bring the interlock circuit 36 into the open state. Upon detecting that the interlock circuit 36 is in the open state (step S2), the EV-ECU 30 may transmit a control signal adapted to bring the SMR 16 into the open state, to the BMS 18 included in the high-voltage battery unit 14. Upon receiving the control signal, the BMS 18 may block the SMR 16 (i.e., turn off the SMR 16) (step S3). In this way, the supply of the electric power from the high-voltage battery 12 may be blocked.

Note that a control signal from the EV-ECU 30 may be transmitted via a signal line 38-1, 38-3, or 38-4, and a control signal from the BMS 18 may be transmitted via a signal line 38-2.

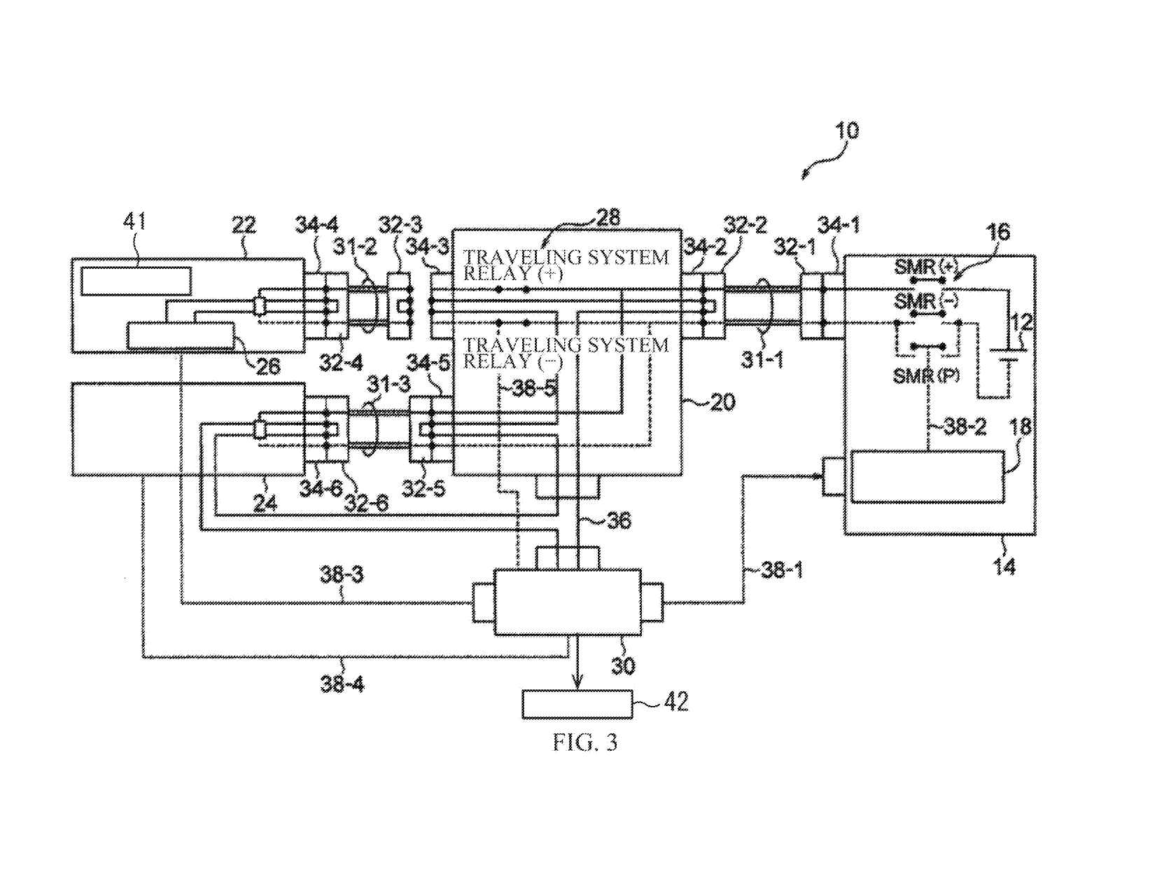

FIG. 3 is a diagram illustrating the high-voltage circuitry 10 in such a state. In FIG. 3, the uncoupled connector of the interlock circuit 36 is illustrated as the connector 32-3.

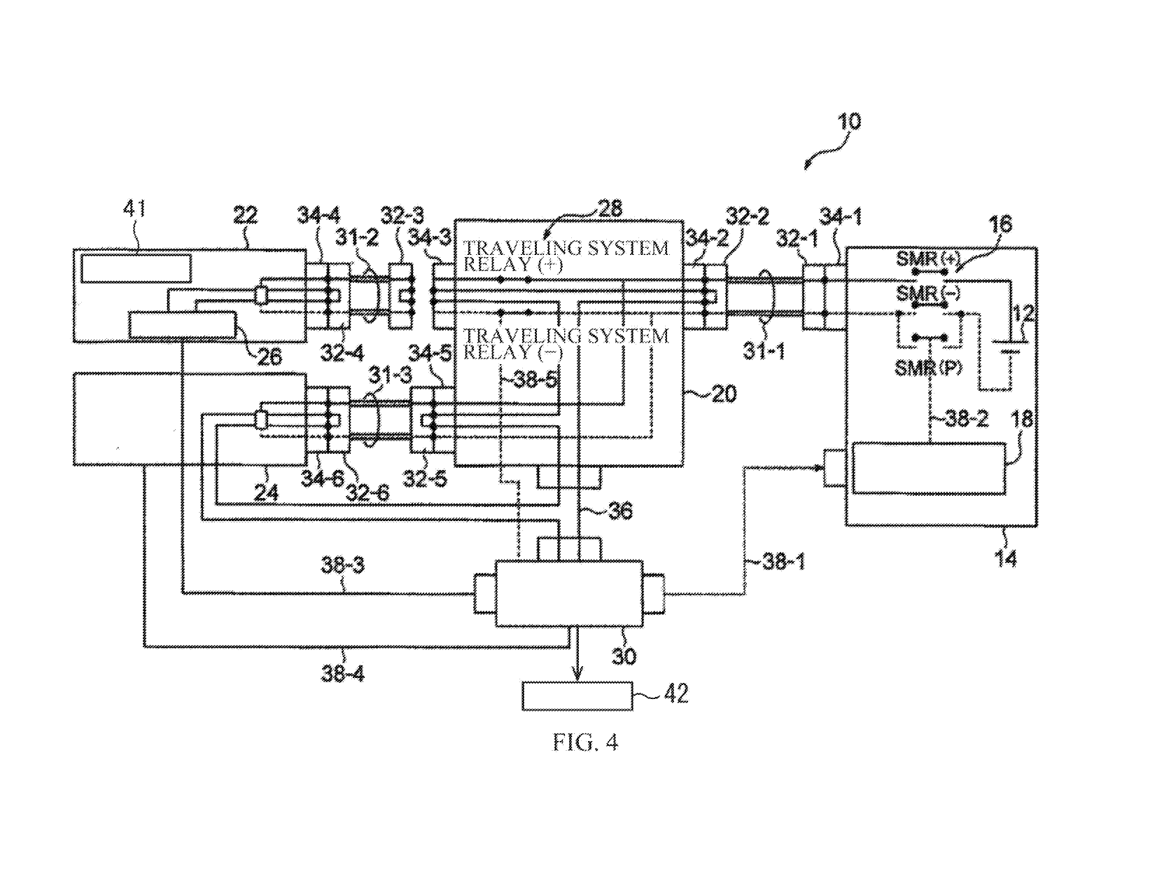

Thereafter, the EV-ECU 30 may transmit a control signal adapted to discharge the residual charge of the vehicle, to the MG-ECU 26 included in the traveling system 22 (step S4). FIG. 4 is a diagram illustrating the high-voltage circuitry 10 in such a state.

The EV-ECU 30 may transmit the control signal adapted to discharge the residual charge of the vehicle, to the MG-ECU 26. The control signal may be transmitted via the signal line 38-3 indicated by a solid line in FIG. 4. Upon receiving the control signal, the MG-ECU 26 may perform the control that discharges the residual charge of the vehicle including the devices such as the motor or the inverter of the traveling system 22.

The residual charge may be discharged by various methods. In some embodiments where the residual charge is discharged with a three-phase alternating-current motor, the residual charge may be consumed by causing an electric current of the residual charge to flow through a winding of one phase alone of the three-phase alternating-current motor to allow the winding to generate heat. In some embodiments, a discharge circuit 41 adapted to cause the residual charge to flow through a discharge resistor may be provided in addition to a switching circuit adapted to drive the motor, and the residual charge may be consumed by causing the electric current of the residual charge to flow through the discharge resistor.

In the high-voltage circuitry 10 illustrated in FIG. 4 in which the connector 32-3 is uncoupled, the non-traveling system 24 may not decrease in the voltage even when the MG-ECU 26 performs the control that discharges the residual charge of the vehicle upon receiving the control signal adapted to discharge the residual charge of the vehicle. In other words, although the non-traveling system 24 normally decreases in the voltage upon discharging the residual charge of the vehicle, the non-traveling system 24 in FIG. 4 may not decrease in the voltage because the residual charge of the vehicle is not entirely discharged when the traveling system 22 and the non-traveling system 24 are not electrically coupled (coupled in parallel) to each other.

The EV-ECU 30 may detect that the non-traveling system 24 has not decreased in the voltage, via the signal line 38-4.

In some embodiments, the detection as to whether the voltage has decreased or identification as to which part of the high-voltage circuitry 10 is uncoupled may be performed by determining that the electric current does not flow even when a drive instruction is given from a vehicle-side component, with respective electric current sensors provided in the high-voltage battery unit 14, the electric power distributor 20, the traveling system 22, the non-traveling system 24, the MG-ECU 26, and the EV-ECU 30. In some embodiments, the detection as to whether the voltage has decreased or the identification as to which part of the high-voltage circuitry 10 is uncoupled may be performed by determining that any of the high-voltage battery unit 14, the electric power distributor 20, the traveling system 22, the non-traveling system 24, the MG-ECU 26, and the EV-ECU 30 is in the off state if a voltage of a capacitor becomes the same as a voltage of the high-voltage battery 12 faster than normal after the residual charge of the vehicle is discharged and the high-voltage circuitry 10 is turned off and then turned on.

Thereafter, the EV-ECU 30 may determine whether the residual charge of the vehicle has been discharged (step S5). The EV-ECU 30 may perform this determination via the MG-ECU 26.

If determining that the residual charge of the vehicle has been discharged (step S5: YES), the EV-ECU 30 may cause the vehicle to stand by while the SMR 16 is turned off (step S6), and end the flow. If determining that the residual charge of the vehicle has not been discharged (step S5: NO), the EV-ECU 30 may determine whether all the devices except for the traveling system 22 (i.e., the non-traveling system 24) have decreased in the voltage (step S7).

If the non-traveling system 24 has decreased in the voltage (step S7: YES), the EV-ECU 30 may cause the vehicle to stand by while the SMR 16 is turned off (step S8), and end the flow. Note that such a situation where the non-traveling system 24 decreases in the voltage may not arise in the high-voltage circuitry 10 illustrated in FIG. 4.

If the non-traveling system 24 has not decreased in the voltage (step S7: NO), the EV-ECU 30 may determine that the connector 32-3 or 32-4 of the traveling system 22 is uncoupled (step S9). Thereafter, the EV-ECU 30 may turn off the traveling system relay 28 included in the electric power distributor 20, and turn on the SMR 16 (step S10). The on and off control of these components may thus be performed by the EV-ECU 30.

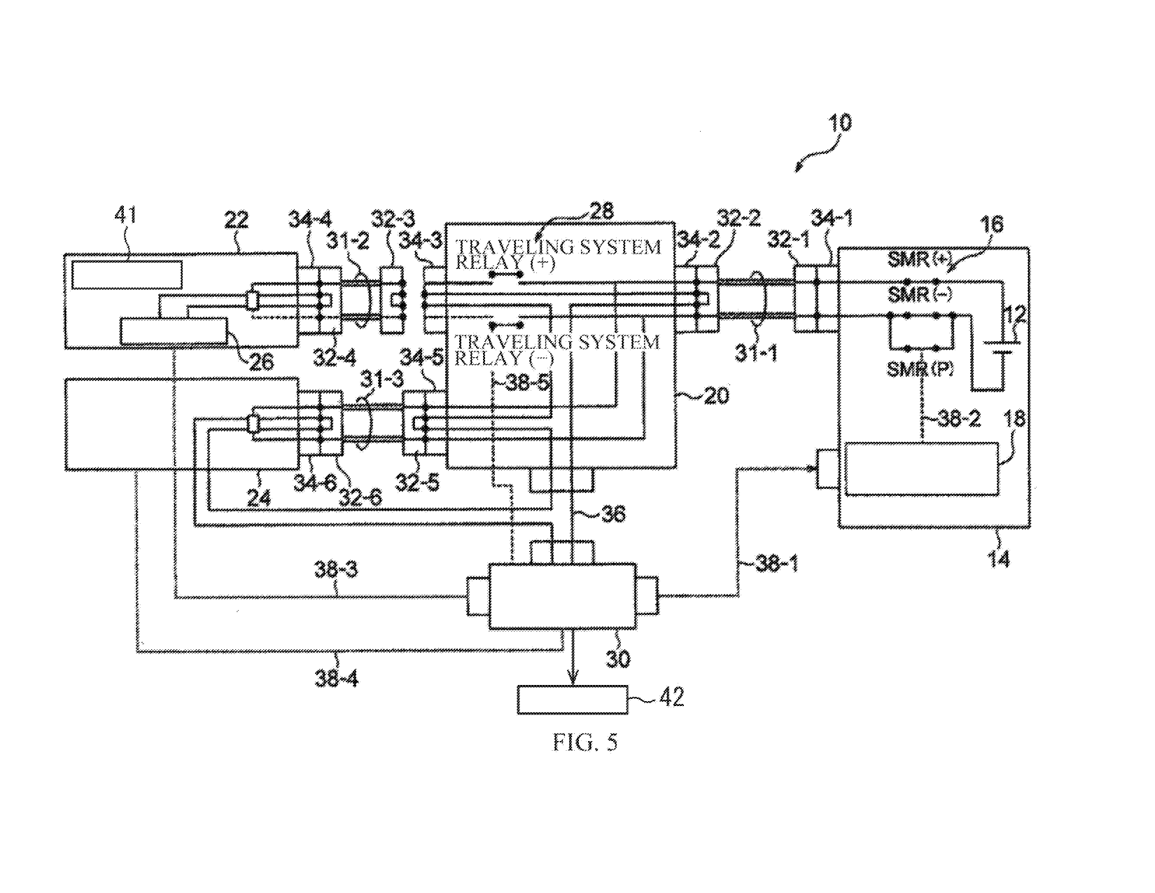

In this way, the non-traveling system 24 may be supplied with the electric power to make the devices such as the heater or the electric compressor usable (step S11). FIG. 5 is a diagram illustrating the high-voltage circuitry 10 in such a state. The non-traveling system 24 may be supplied with the electric power from the high-voltage battery 12 while the SMR 16 is in the on state and the traveling system relay 28 is in the off state.

Further, the traveling system 22 may not be supplied with the electric power from the high-voltage battery 12 because the traveling system relay 28 is in the open state and the connector 32-3 is uncoupled.

In the high-voltage circuitry system for the vehicle according to the present example embodiment, when the supply of the electric power from the high-voltage battery 12 is blocked by the control based on the operation of the interlock circuit 36, the in-vehicle devices included in the non-traveling system 24 may be automatically made usable while the vehicle is in a standby state until a person such as a rescue worker performs the next processing.

When restoration work is performed in the nonnormal situation such as the unexpected event of the vehicle, the supply of the electric power from the high-voltage battery 12 may be blocked to ensure safety of the restoration work. While the supply of the electric power from the high-voltage battery 12 is blocked, necessity of using the in-vehicle devices of the non-traveling system 24 can arise in some cases. In such cases, because it is confirmed that the traveling system 22 is not supplied with the electric power, the non-traveling system 24 may be supplied with the electric power from the high-voltage battery 12 after safety of an operator is confirmed. This helps to make the non-traveling system 24 usable even in the nonnormal situation.

In some embodiments, the electric power distributor 20 may include the traveling system relay 28 configured to switch the state of the supply of the electric power from the high-voltage battery unit 14 to the traveling system 22 between the on state and the off state. The EV-ECU 30 may be configured to turn off the traveling system relay 28 before turning on the SMR 16. This helps to supply the non-traveling system 24 with the electric power while reliably preventing the supply of the electric power from the high-voltage battery unit 14 to the traveling system 22.

Such a configuration helps to ensure that a safety condition prior to supplying the electric power to the non-traveling system 24 is satisfied, reliably preventing the electric power from being supplied to the traveling system 22 and thereby reliably avoiding the incident including the electric shock with the high voltage when the vehicle is in the standby state.

In some embodiments, the traveling system 22 may include the discharge circuit 41 configured to discharge the residual charge. The discharge circuit 41 may be configured to be operated and controlled by the EV-ECU 30. The traveling system 22 and the non-traveling system 24 may be electrically coupled in parallel to each other, and the EV-ECU 30 may be configured to determine that the traveling system 22 and the high-voltage battery 12 are uncoupled from each other, by detecting that the non-traveling system 24 has not decreased in the voltage after transmitting the control signal adapted to discharge the residual charge to the discharge circuit 41 of the traveling system 22.

In other words, when the non-traveling system 24 has not decreased in the voltage even upon performing the control that causes the discharge circuit 41 of the traveling system 22 to discharge the residual charge, the traveling system 22 and the non-traveling system 24 may be determined not to be coupled in parallel to each other. In this case, although which coupling part is blocked is unidentifiable, the non-traveling system 24 and the electric power distributor 20 may remain coupled to each other. In contrast, upon performing the control that causes the traveling system 22 to discharge the residual charge of the vehicle when the traveling system 22 and the non-traveling system 24 remain electrically coupled in parallel to each other, the non-traveling system 24 may also discharge its residual charge and decrease in the voltage.

Such a configuration helps to confirm, in the circuitry, that the traveling system 22 and the high-voltage battery 12 are uncoupled from each other (i.e., an uncoupled state of the traveling system 22), further improving the reliability. After the uncoupled state of the traveling system 22 is confirmed, the SMR 16 of the high-voltage battery unit 14 may be turned on to thereby supply the electric power from the high-voltage battery 12 to the non-traveling system 24. This further improves the safety of the operator. For example, even if a device such as the motor of the traveling system 22 is exposed due to the unexpected event of the vehicle, the safety is ensured.

In some embodiments, the vehicle may include an audio output circuit 42 configured to be operated and controlled by the EV-ECU 30. Even in a situation where the vehicle itself is unable to travel when the high-voltage battery 12 and the traveling system 22 are electrically uncoupled from each other, the audio output circuit 42 may output an audio notification indicating that the in-vehicle devices of the non-traveling system 24 are usable.

The user cannot recognize that the non-traveling system 24 alone is supplied with the electric power, based on external circumstances. The audio notification outputted by the audio output circuit 42 thus helps to encourage the user to use the in-vehicle devices of the non-traveling system 24. This helps to more appropriately achieve an example effect provided by using the high-voltage circuitry system according to the present example embodiment.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

In the foregoing example embodiment, the interlock circuit 36 may be formed in a loop by providing wiring adapted to detect its open state and closed state to the connectors 32-2, 32-3, 32-5, and 32-6; however, this is non-limiting. In some embodiments, the interlock circuit 36 may be formed by incorporating any other connector.

In the high-voltage circuitry system for the vehicle according to the foregoing example embodiment, even when the high-voltage battery 12 is blocked based on the open state of the interlock circuit 36 in the nonnormal situation such as where the unexpected event including the contact of the vehicle occurs, the EV-ECU 30 may turn on the SMR 16 of the high-voltage battery 12 after the safety is confirmed, to thereby supply the non-traveling system 24 with the electric power.

Such a configuration may automatically set the various in-vehicle devices to be usable by the user when the vehicle is in the standby state until the person such as the rescue worker performs the next processing. In other words, the configuration may supply the non-traveling system 24 alone with the electric power after confirming that the high-voltage battery 12 and the traveling system 22 are electrically uncoupled from each other, making an air conditioner usable by the user.

In the standby period in a severe winter, a high-temperature environment, or any other situation, even if the user does not have an understanding of an electrical structure, the configuration may automatically set the devices such as the air conditioner to be usable. This helps to avoid an occurrence of a secondary effect including sickness. Further, because it is confirmed that the traveling system 22 is not supplied with the electric power, the safety of the user and the operator is considered and ensured.

In the high-voltage circuitry system for the vehicle according to at least one embodiment of the disclosure, in the nonnormal situation such as the expected event including the contact of the vehicle, the non-traveling system 24 is automatically set to be usable to allow the user of the vehicle to use the devices such as the air conditioner when the vehicle is in the standby state. This helps to avoid the occurrence of the secondary effect including the sickness. Further, the high-voltage circuitry system according to the at least one embodiment of the disclosure confirms that the traveling system 22 is not supplied with the electric power, the safety of a person such as the operator is considered and ensured.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term "substantially", "approximately", "about", and its variants having a similar meaning thereto are defined as being largely but not necessarily wholly what is specified as understood by one of ordinary skill in the art.

The term "disposed on/ provided on/ formed on" and its variants having a similar meaning thereto as used herein refer to elements disposed directly in contact with each other or indirectly by having intervening structures therebetween.

As used herein, the term "collision" may be used interchangeably with the term "contact".

The EV-ECU 30 illustrated in FIGS. 1, 3, 4, and 5 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the EV-ECU 30. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the EV-ECU 30 illustrated in FIGS. 1, 3, 4, and 5.

1. A high-voltage circuitry system for a vehicle, the high-voltage circuitry system comprising:
a high-voltage battery unit comprising a high-voltage battery and a first switcher, the first switcher being configured to switch a state of supply of electric power from the high-voltage battery between an on state and an off state;
a traveling system comprising a traveling device configured to cause the vehicle to travel, the traveling system being configured to be driven by the electric power from the high-voltage battery;
a non-traveling system comprising an in-vehicle device indirectly involved in causing the vehicle to travel, the non-traveling system being configured to be driven by the electric power from the high-voltage battery;
an electric power distributor configured to distribute the electric power supplied from the high-voltage battery to the traveling system and the non-traveling system;
an interlock circuit provided in a route of the supply of the electric power from the high-voltage battery unit to the traveling system and the non-traveling system via the electric power distributor, the interlock circuit being configured to be brought into an open state upon occurrence of a nonnormal situation; and
a vehicle control processor configured to control and monitor the high-voltage battery unit, the traveling system, the non-traveling system, the electric power distributor, and the interlock circuit, wherein
the vehicle control processor is configured to,
when the interlock circuit is brought into the open state, block the high-voltage battery by turning off the first switcher, and
after blocking the high-voltage battery, confirm that the traveling system and the high-voltage battery are electrically uncoupled from each other, and turn on the first switcher.

2. The high-voltage circuitry system according to claim 1, wherein
the electric power distributor comprises a second switcher configured to switch the state of the supply of the electric power from the high-voltage battery unit to the traveling system between the on state and the off state, and
the vehicle control processor is configured to turn off the second switcher before turning on the first switcher.

3. The high-voltage circuitry system according to claim 1, wherein
the traveling system comprises a discharge circuit configured to discharge residual charge, the discharge circuit being configured to be operated and controlled by the vehicle control processor,
the traveling system and the non-traveling system are electrically coupled in parallel to each other, and
the vehicle control processor is configured to confirm that the traveling system and the high-voltage battery are electrically uncoupled from each other, by detecting that the non-traveling system has not decreased in voltage after transmitting a control signal adapted to discharge the residual charge of the discharge circuit of the traveling system.

4. The high-voltage circuitry system according to claim 2, wherein
the traveling system comprises a discharge circuit configured to discharge residual charge, the discharge circuit being configured to be operated and controlled by the vehicle control processor,
the traveling system and the non-traveling system are electrically coupled in parallel to each other, and
the vehicle control processor is configured to confirm that the traveling system and the high-voltage battery are electrically uncoupled from each other, by detecting that the non-traveling system has not decreased in voltage after transmitting a control signal adapted to discharge the residual charge of the discharge circuit of the traveling system.

5. The high-voltage circuitry system according to claim 1, wherein
the vehicle comprises an audio output circuit configured to be operated and controlled by the vehicle control processor, and
the audio output circuit is configured to, when the vehicle control processor turns on the first switcher after confirming that the traveling system and the high-voltage battery are electrically uncoupled from each other, output an audio notification indicating that the in-vehicle device of the non-traveling system is usable.
